(19) United States
(12) Patent Application Publication
(10) Pub. No.: US 2002/0153725 A1
(43) Pub. Date: Oct. 24, 2002

(54) Self-sealing gasket

(75) Inventor: Jerome J. Myers, Maple Grove, MN (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: Sheet Metal Connectors, Inc., Minneapolis, MN

(21) Appl. No.: 10/121,459

(22) Filed: Apr. 12, 2002

Related U.S. Application Data
(60) Provisional application No. 60/284,844, filed on Apr. 18, 2001.

(51) Int. Cl. F16L 55/00

(52) U.S. Cl. 285/370; 285/148.18

(57) ABSTRACT

An air duct connector is used to create an air-tight connection for duct work. A method of using the air duct connector includes cutting a strip of an air duct connection gasket along a first start edge. The strip is adhesively attached around a metal connector band such that the air duct connection gasket fully encircles the metal connector band and an adhesive attachment is formed with an adhesive backing. The strip is cut along a second close edge which matches the first start edge and the strip is positioned such that the first start edge mates together with the second close edge at a sealing seam. The air duct connection gasket includes a first sheet section extending generally in a planar sheet between a first side edge and a first central edge. The first sheet section has a first sheet width which is substantially wider than a first sheet thickness. A first sealing rib extends longitudinally on a front face of the first sheet section and defines a flexible fin. The air duct connection gasket also includes a second sheet section extending generally in a planar sheet between a second side edge and a second central edge. The second sheet section has a second sheet width which is substantially wider than a second sheet thickness. A second sealing rib extends longitudinally on a front face of the second sheet section and defines a flexible fin. A bead extends longitudinally between the first and second sheet sections along the central edges. The bead has a thickness which is substantially thicker than the first sheet thickness and the second sheet thickness, and the bead has a width which is substantially narrower than the first sheet width and the second sheet width. The adhesive backing is located on a back face of the first and second sheet sections opposite the front faces.

### CROSS-REFERENCE TO RELATED APPLICATION(S)

This application claims priority from Provisional Application No. 60/284,844, filed Apr. 18, 2001, for “SELF-SEALING GASKET” by Jerome J. Myers.

### BACKGROUND OF THE INVENTION

The present invention is a self-sealing gasket for creating an airtight connection for duct work and fittings which are typically used in the heating, ventilating and air conditioning (HVAC) industry. The gasket is capable of fitting a plurality of variously shaped duct work fittings and piping.

HVAC systems utilize air ducts to convey and circulate air through a building (residential, commercial or industrial) from location to location. Some HVAC systems may be used for outside applications. Once installed, the air ducts connect a plenum to a register located in one or more rooms. The duct system within an HVAC system is comprised of multiple segments of duct having various lengths and diameters. A joint is formed at the point where two duct segments are attached together. Generally, the joint is sealed to prevent air leakage from the HVAC system.

The most basic way to seal a joint between air ducts is with duct tape. However, a loss of the tape's seal occurs over time and with high temperatures. Sealant has replaced duct tape as the preferred way of sealing a joint between air ducts. Typically, sealant is applied to the duct work with brushes or by hand in the field. The application of a sealant to duct work is a labor-intensive and time-consuming process. Also, many of the sealants are solvent-based and thus harmful to both people and the environment.

Some HVAC systems utilize gaskets or circumferential rubber seals to seal joint coupling duct segments. The gaskets are either a rigid tubular body or a flexible elastic strip attached to an end of one or both duct segments and used to create an air-tight seal between two pieces of duct. Some systems utilize a duct joint connector having a gasket attached to an outer surface of a connector duct member. The two duct segments to be coupled are attached at opposite ends to the duct joint connector whereby the duct joint connector forms the air-tight joint between the duct segments. However, properly positioning and attaching the gasket to the connector duct member in the field is time-consuming and labor-intensive.

One type of prior art duct joint connector is described in U.S. Pat. No. 6,322,111, which discloses a prefabricated coupling connector for joining and sealing air ducts. The coupling connector is comprised of a metal connector and a gasket material encircling an outer surface of the metal connector. The gasket material includes first and second gaskets where the first gasket wraps around a first edge of the metal connector and the second gasket wraps around a second edge of the metal connector.

The prefabricated coupling connector has limited and inflexible use in the field and limits the HVAC system to a specific sized metal connector or duct segment. A contractor will order the exact number of coupling connectors needed in the field for specific sized air ducts. If the contractor runs out of coupling connectors or the air duct size is not compatible with the coupling connector size, time and money is lost while a replacement is found or fabricated. Furthermore, manufacturing of the coupling connector is time-consuming. Attaching the gasket to the metal connector requires axial movement of the gasket along an edge of the metal connector as the gasket is slid onto the metal connector. Given the dimensions, material and tight fit of the gasket, assembly is difficult and inefficient.

An air duct connector is desired in the art that is quick and easy to assemble in the field and does not use solvent-based sealants. The present invention provides an air-tight joint for duct work without the use of solvent-based sealants that is faster, easier and cleaner to install in the field without harming people or the environment, and can be used with duct having various widths and diameters.

### BRIEF SUMMARY OF THE INVENTION

The present invention is an air duct connector and a method of using the air duct connector. A strip of an air duct connection gasket is cut along a first start edge. The strip is adhesively attached around a metal connector band such that the air duct connection gasket fully encircles the metal connector band and an adhesive attachment is formed with an adhesive backing. The strip is cut along a second close edge which matches the first start edge and the strip is positioned such that the first start edge mates together with the second close edge at a sealing seam.

In one aspect of the invention, te air duct connection gasket includes a first sheet section extending generally in a planar sheet between a first sheet longitudinal side edge and a first sheet longitudinal central edge. The first sheet section has a first sheet width which is substantially wider than a first sheet thickness. A first sealing rib extends longitudinally on a front face of the first sheet section and defines a flexible fin. The air duct connection gasket also includes a second sheet section extending generally in a planar sheet between a second sheet longitudinal side edge and a second sheet longitudinal central edge. The second sheet section has a second sheet width which is substantially wider than a second sheet thickness. A second sealing rib extends longitudinally on a front face of the second sheet section and defines a flexible fin. A bead extends longitudinally between the first and second sheet sections along the longitudinal central edges. The bead has a bead thickness which is substantially thicker than the first sheet thickness and the second sheet thickness, and the bead has a bead width which is substantially narrower than the first sheet width the second sheet width. An adhesive backing is located on a back face of the first and second sheet sections opposite the front faces.

In one embodiment of the invention, a first bead extends longitudinally along the first sheet longitudinal central edge and a second bead extends longitudinally along the second sheet longitudinal central edge. A connection bridge attaches the first bead and the second bead, the connection bridge has a thickness smaller than either the first or second sheet thickness. The air duct connector is separable into a first gasket and a second gasket along the connection bridge.

In another embodiment of the invention, the gasket is comprised of a flexible strip having a front face and a back face, the strip extending laterally between a first side edge and a second side edge. A projection extends from the front face of the strip and along the second side edge. At least one sealing rib extends longitudinally on the front face of the strip wherein the sealing rib defines a flexible fin. The gasket also includes an adhesive backing for attaching the gasket to an outer surface of a metal connector band.

### BRIEF DESCRIPTION OF THE DRAWINGS

FIG. 1 is a top perspective view of an air duct connector of the present invention.

FIG. 2 is a bottom perspective view of the air duct connector of the present invention.

FIG. 3 is a cross-sectional view of the air duct connector shown in FIGS. 1 and 2.

FIG. 4 is a cross-sectional view of an alternate embodiment of the air duct connector of the present invention.

FIG. 5 is a side perspective view of the air duct connector wrapped about a connector duct member.

FIG. 6 is a side perspective view of a duct joint member.

FIG. 7 is a top view of a preferred embodiment of ends of the air duct connector shown in FIG. 5.

FIG. 8 is a top view of the ends of the air duct connector shown in FIG. 5 forming a sealing seam.

FIG. 9 is a top view of the ends of the air duct connector shown in FIG. 5 forming the sealing seam.

FIG. 10 is a cross-sectional view of the duct joint member.

FIG. 11 is a cross-sectional view of the duct joint member coupled with a first duct member.

FIG. 12 is a front perspective view showing separability of the air duct connector.

FIG. 13 is a cross-sectional view of a duct joint member including the air duct connectors of FIG. 12.

While the above-identified drawing figures set forth one preferred embodiment, other embodiments of the present invention are also contemplated, some of which are noted in the discussion. In all cases, this disclosure presents the illustrated embodiments of the present invention by way of representation and not limitation. Numerous other minor modifications and embodiments can be devised by those skilled in the art which fall within the scope and spirit of the principles of this invention.

### DETAILED DESCRIPTION

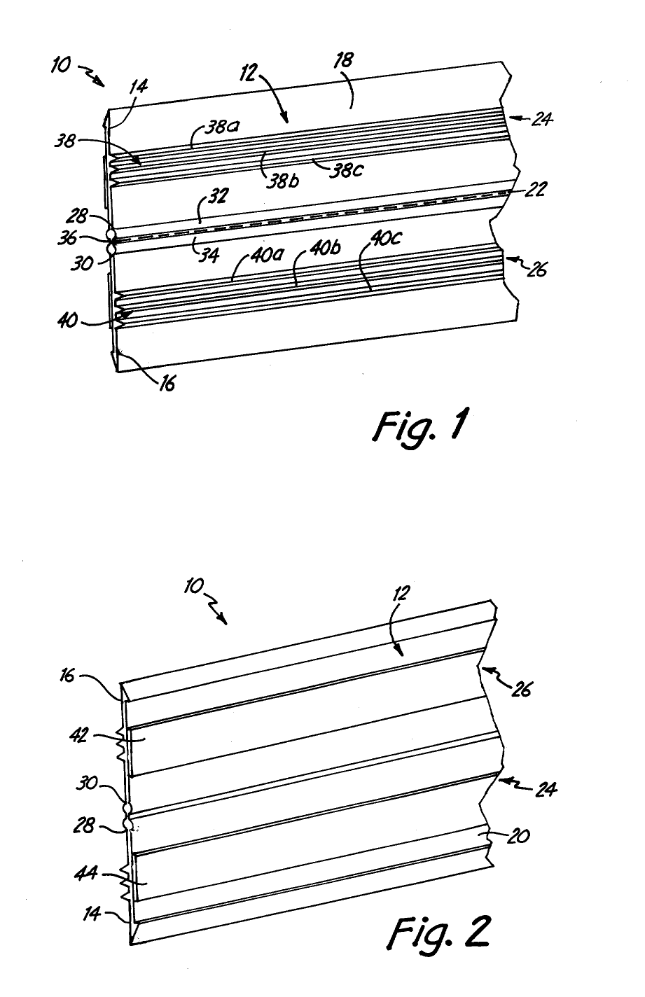

FIGS. 1 and 2 are a top perspective view and a bottom perspective view, respectively, of an air duct connector 10 of the present invention. The air duct connector 10 is used to create an air-tight seal at a duct joint coupling air ducts and fittings, and preferably between two segments of duct.

The air duct connector 10 is formed from an air duct connection gasket 12, which is preferably a single strip of flexible, compressible material. The gasket 12 is preferably formed by extrusion. The gasket 12 extends laterally between a first side edge 14 and a second side edge 16, and has a front face 18 and a back face 20. The gasket 12 is a generally planar sheet having a longitudinal axis 22 that divides the gasket 12 into a first sheet section 24 and a second sheet section 26. The first sheet section 24 extends between the first side edge 14 and a first central edge 28 adjacent the longitudinal axis 22, and the second sheet section 26 extends between the second side edge 16 and a second central edge 30 adjacent the longitudinal axis 22. The first central edge 28 and the second central edge 30 are longitudinally aligned with each other. The first and second side edges 14 and 16, as well as the first and second center edges 28 and 30, run longitudinally along the gasket 12.

A first bead 32 extends longitudinally along the first central edge 28 of the gasket 12 and a second bead 34 extends longitudinally along the second central edge 30. Both the first bead 32 and the second bead 34 extend substantially perpendicular from the front face 18 of the gasket 12. A connection bridge 36 attaches the first bead 32 and the second bead 34 and extends longitudinally along the longitudinal axis 22 of the gasket 12.

First sealing ribs 38 extend longitudinally along the front face 18 of the first sheet section 24. The first sealing ribs 38 are located between the first side edge 14 and the first bead 32. Second sealing ribs 40 extend longitudinally along the front face 18 of the second sheet section 26 and are located between the second side edge 16 and the second bead 34. Preferably, the first and second sealing ribs 38, 40 are each comprised of three flexible fins (38a, 38b, 38c, 40a, 40b, 40c). The flexible fins 38, 40 create the air-tight seal at the joint coupling air duct segments. The sealing ribs 38, 40 are flexible and bend downward parallel to the front face 18 of the gasket 12 when an air duct member is coupled with the air duct connector 10.

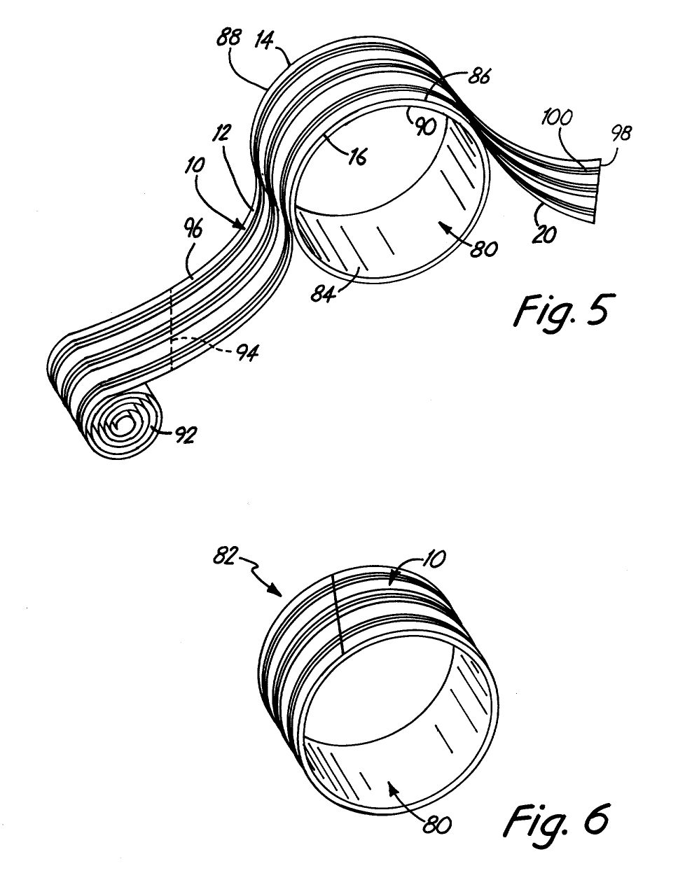

A first adhesive backing 42 and a second adhesive backing 44 lie on the back face 20 of the gasket 12. The first adhesive backing 42 extends longitudinally along the back face 20 at the first sheet section 24 and opposite the first sealing ribs 38 and the second adhesive backing 44 extends longitudinally along the back face 20 at the second sheet section 26 and opposite the second sealing ribs 40. Preferably, the first and second adhesive backings 42, 44 are comprised of an adhesive strip protected by a self-peeling layer (not shown) prior to attachment to a connector duct member (shown in FIG. 5). The adhesive backings are preferably pressure sensitive. The use of an adhesive backing on the back face 20 of the gasket 12 rather than a sealant to attach the gasket 12 to a connector duct member is faster and cleaner to install, and is not harmful to the installer or environment as a sealant. As known by those skilled in the art, the adhesive backing could include adhesive tabs or another configuration of adhesive, or be located on the connector duct member the gasket 12 is attached to.

Preferably, the air duct connector 10 is approximately 4.5 inches wide and has a relatively thin cross-sectional thickness of about 0.032 inches. The thin cross-sectional thickness minimizes the friction between an outer surface of the duct joint (connector duct member) and an inner surface of the adjoining duct member (air duct segment). The cross-sectional thickness is preferably uniform across the width of the air duct connector. The gasket 12 is preferably made from an elastic material, such as an EPDM rubber.

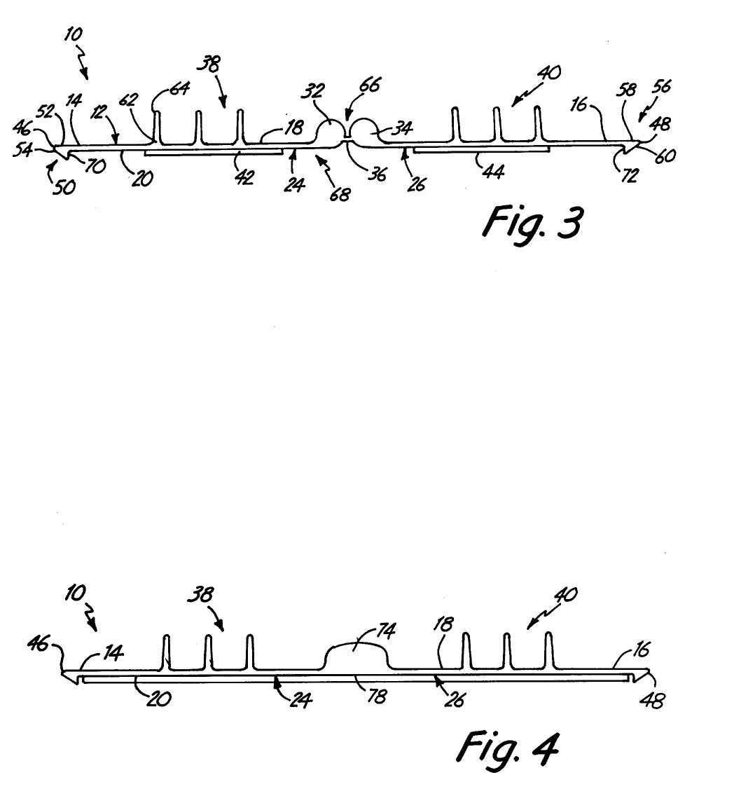

FIG. 3 is a cross-sectional view of the air duct connector 10 shown in FIGS. 1 and 2. The gasket 12 of the present invention extends between the first side edge 14 and the second side edge 16, and this preferred embodiment includes a first knife edge 46 and a second knife edge 48 extending along the first and second side edges 14 and 16, respectively. The first knife edge 46 is defined by a first tapered section 50 extending longitudinally along the first side edge 14 of the first sheet section 24. The first tapered section 50 has a front face 52 coplanar with the front face 18 of the gasket 12. The first tapered section 50 includes a rear face 54 which widens from the first knife edge 46 and extends at an angle relative to the back face 20 of the gasket 12. A second tapered section 56 extends longitudinally along the second side edge 16 of the second sheet section 26. The second tapered section 56 has a front face 58 coplanar with the front face 18 of the gasket 12. A rear face 60 of the second tapered section 56 widens from the second knife edge 48 and extends at an angle relative to the back face 20 of the gasket 12. The gasket 12 preferably has a width of about 4.5 inches from knife edge to knife edge, and about 4.15 inches from side edge to side edge.

The first sealing ribs 38 are positioned between the first knife edge 46 and the first bead 32 and the second sealing ribs 40 are positioned between the second knife edge 48 and the second bead 34. The flexible fins 38, 40 preferably extend perpendicularly from the front face 18 of the gasket 12, extending from a base 62 of the fin to a top 64 of the fin. Each flexible fin preferably has a height of about 0.275 inches and a lateral cross-sectional width that decreases from the base 62 to the top 64. The width of the fins 38, 40 at the base 62 is about 0.0625 inches and at the top 64 is about 0.031 inches. The sealing ribs 38, 40 are flexible and bend downward from the base 62, parallel to the front face 18, when the air duct connector 10 forms the air-tight seal between air duct segments (as seen in FIG. 11).

The first bead 32 extends longitudinally along the first central edge 28 of the first sheet section 24 and the second bead 34 extends longitudinally along the second central edge 30 of the second sheet section 26. The beads preferably have a semicircular cross-sectional shape. Preferably, the first and second beads 32, 34 have a diameter of about 0.2 inches, greater than the thickness of the gasket 12 and smaller than the width of the gasket 12.

The connection bridge 36 extends longitudinally along the longitudinal axis 22 and attaches the first bead 32 and the second bead 34. The connection bridge 36 has a thickness smaller than the thickness of the gasket 12 and a width narrower than the width of either the first bead 32 or the second bead 34. The connection bridge 36 forms a channel 66 between the first and second beads 32, 34.

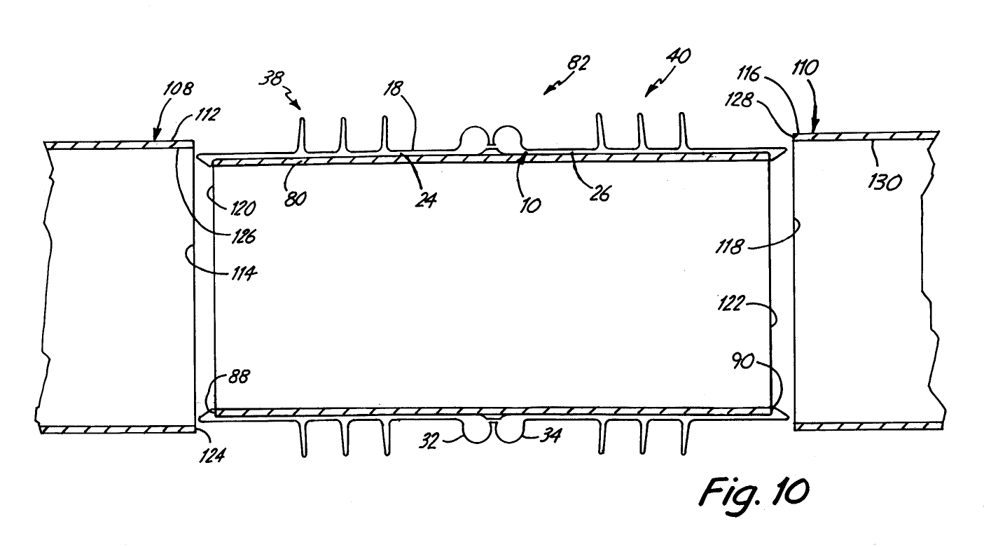

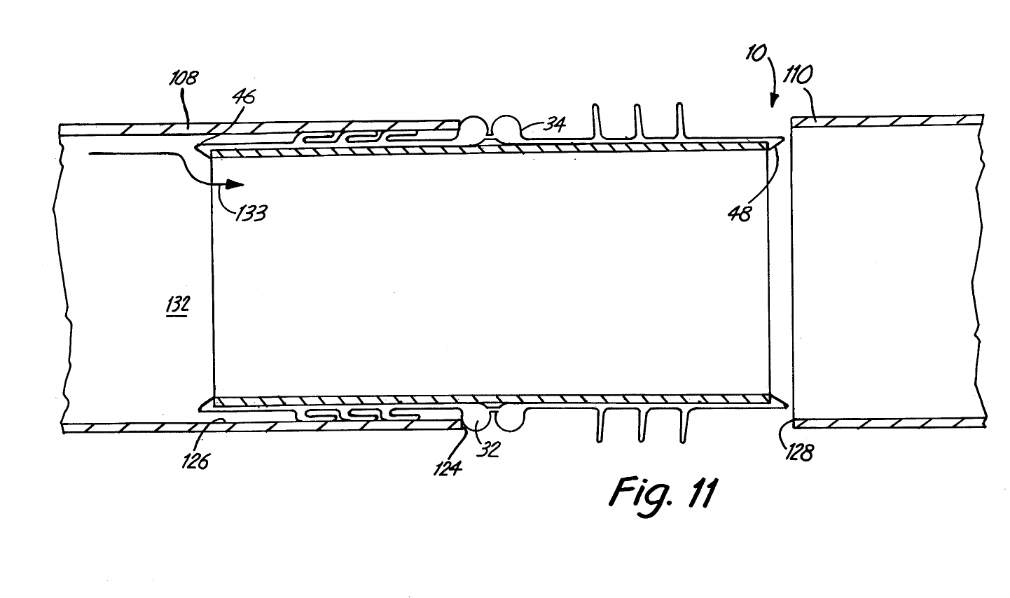

This preferred embodiment of the present invention includes a notch 68 which extends longitudinally along the back face 20 of the gasket 12. The notch 68 extends laterally across the first and second sheet sections 24, 26 between the first side edge 14 and the second side edge 16. The notch 68 has a first notch end 70 adjacent the first side edge 14 and a second notch end 72 adjacent the second side edge 16 wherein the first and second notch ends 70, 72 define the notch 68. The notch 68 preferably has a width of about 4.1 inches. Preferably, the notch 68 is sized to receive a connector duct member (as seen in FIG. 10). However, if the connector duct member is wider than the notch 68, the notch ends 70, 72 are compressed up towards the back face 20 of the gasket 12.

FIG. 4 is a cross-sectional view of an alternate embodiment of the air duct connector 10. The air duct connector 10 of this embodiment has the same general configuration as the embodiment discussed with respect to FIGS. 1-3. However, this preferred embodiment has a single bead 74 and a single adhesive backing 76. The bead 74 extends longitudinally along the longitudinal axis 22 of the gasket 12 and connects the first sheet section 24 and second sheet section 26. The bead 74 extends substantially perpendicular from the front face 18 of the gasket 12, however, a bottom 78 of the bead 74 may extend slightly downward from the back face 20 of the gasket 12. The bead 74 has a width which is substantially narrower than the widths of either the first and second sheet sections 24, 26. A thickness of the bead 74 is substantially thicker than the thickness of the gasket 12.

In addition, the air duct connector 10 of this preferred embodiment has the single adhesive backing 76 extending longitudinally along the back face 20 of the gasket 12. The adhesive backing 76 is preferably centered opposite the bead 74 and the front face 18 of the sheet sections. Although, the adhesive backing 76 in FIG. 4 is shown extending laterally from the first side edge 14 to the second side edge 16, the adhesive backing 76 may have a narrower width.

FIG. 5 is a side perspective view of the air duct connector 10 wrapped about a connector duct member 80 to form a duct joint member 82 (shown in FIG. 6). The duct joint member 82 couples a first duct member and second duct member together to form an air-tight duct joint, with the air duct connector 10 creating the air tight seal (shown in FIG. 11).

The connector duct member 80 is preferably a metal connector band having an inner surface 84 and an outer surface 86. The air duct connector 10 is attached to the outer surface 86 of the connector duct member 80 by the adhesive backings 42, 44. The connector duct member 80 maybe round, rectangular or oval depending upon the air duct segments it is coupling, however, the connector duct member 80 preferably is round. The connector duct member 80 is preferably formed by bending or folding a piece of sheet metal. The connector duct member 80 has a first side edge 88 and a second side edge 90. The connector duct member 80 has a width approximately equal to the width of the gasket 12. However, the air duct connector 10 may still be used with connector duct members having widths larger or smaller than the gasket width.

In the field, a correctly sized connector duct member is selected to connect two air duct segments or a duct member to a duct fitting. Preferably, the air duct connector 10 is stored and shipped as a rolled gasket material 92. A strip of gasket is cut from gasket material 92 to form the air duct connector 10. An initial cut is made to form a first start edge 94 at a first end 96 of the air duct connector 10 and a second cut is made to form a second close edge 98 at a second end 100 of the air duct connector 10. The strip has a length necessary to fully encircle the connector duct member 80.

Either prior to the second cut or after the strip has been formed, the air duct connector 10 is wrapped around the connector duct member 80 until it fully encircles the connector duct member 80. The first and second side edges 14 and 16 of the air duct connector 10 are longitudinally aligned with the first and second side edges 88, 90 of the connector duct member 80. In addition, the strip is positioned such that the first start edge 94 and the second close edge 98 mate together to form a sealing seam 102. FIG. 6 is a side perspective view of the duct joint member 82 illustrating the sealing seam 102. The back face 20 of the gasket 12 contacts the outer surface 86 of the connector duct member 80 and the adhesive backings 42, 44 attaches the two. Preferably, a self-peeling protective layer is removed from the adhesive backings 42, 44 prior to attaching the gasket 12.

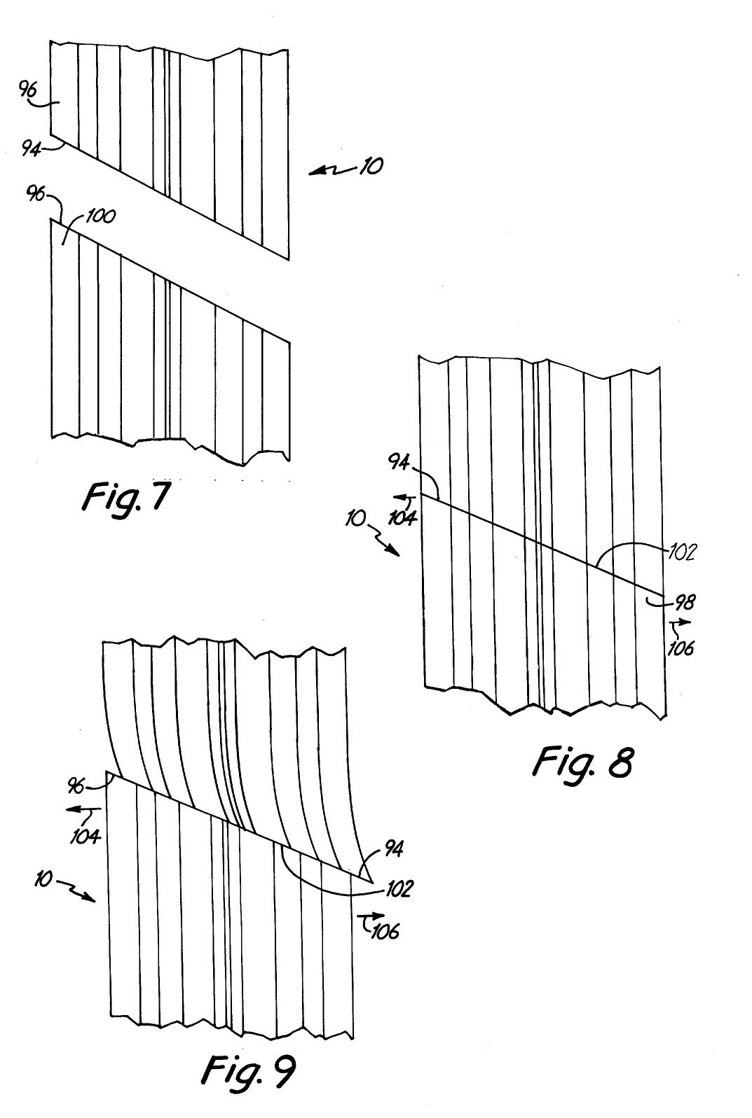

FIGS. 7 and 8 show a top view of the preferred embodiment of the ends of the air duct connector 10 shown in FIG. 5, with FIG. 8 showing the first start edge 94 and the second close edge 98 mated together to form the sealing seam 102. The first start edge 94 is preferably cut at an angle non-perpendicular to the first and second side edges 14, 16 of the air duct connector 10. Once the desired length of the air duct connector 10 is determined or the air duct connector 10 is wrapped around and fully encircles the connector duct member 80, the second cut is made to form the second close edge 98. The second close edge 98 is cut at an angle non-perpendicular to the first and second side edges 14, 16 of the gasket 12, such that the first start edge 94 and the second close edge 98 match each other. Once the gasket material 92 fully encircles the connector duct member 80, the air duct connector 10 is positioned such that the first start edge 94 and the second close edge 98 mate to form the sealing seam 102 (shown in FIGS. 6 and 8). In FIG. 8, the air duct connector 10 has been cut the proper length and when the first start edge 94 and a second close edge 98 are mated, the ends of the air duct connector 10 are exactly aligned such that the first and second sealing ribs 38, 40 and the first and second beads 32, 34 are continuous.

FIG. 9 is a top view of the ends of the air duct connector 10 when the air duct connector strip is not cut the proper length. In the field when the second cut is made to form the second close edge 98, oftentimes the length of the air duct connector 10 may be longer or shorter than the proper length. If the air duct connector 10 length is too long or short to mate the first start edge 94 and the second close edge 98 to form the sealing seam 102, the second close edge 98 is laterally shifted to the left or the right (as seen by arrows 104, 106 in FIG. 9) when positioning the air duct connector 10. The second close edge 98 is shifted until the sealing seam 102 is formed between the first start edge 94 and the second close edge 98. In the situation where the air duct connector 10 is too long or too short, the ends of the air duct connector 10 are not perfectly aligned at the sealing seam 102. However, since there is no gap between the ends at the sealing seam 102, the air-tight duct joint will not be compromised. Cutting the first start edge 94 and the second close edge 98 at angle non-perpendicular to the first and second side edges 14, 16 of the air duct connector 10 aids in positioning when the strip is too long or too short without having to start over with a new air duct connector 10.

FIG. 10 is a cross-sectional view of the duct joint member 82 with the air duct connector 10 wrapped about the connector duct member 80. The duct joint member 82 which is used to create a duct joint between a first duct member 108 and a second duct member 110 and create an air-tight seal therebetween. The first duct member 108 has a first end 112 with an opening 114 and the second duct member 110 has a first end 116 with an opening 118. The duct joint member 82 has a first end 120 and a second end 122. The first end 120 is adjacent the first side edge 88 of the connector duct member 80 and the second end 122 is adjacent the second side edge 90 of the connector duct member 80. Preferably, the air duct connector 10 features associated with the first sheet section 24 are located at the first end 120 of the duct joint member 82 and the features associated with the second sheet section 26 are located at the second end 122 of the duct joint member 82. To form the air-tight duct joint between the first and second duct members 108, 110 with the duct joint member 82, the first end 120 of the duct joint member 82 is inserted into the opening 114 of the first duct member 108 and the second end 122 of the duct joint member 82 is inserted into the opening 118 of the second duct member 110.

The gasket 12 seals the duct joint between the duct members airtight and no sealant needs to be applied by hand in the field to finish the joint. Thus, the air duct connector 10 is faster and cleaner to assemble than prior art duct joints and is not harmful to people or the environment.

FIG. 11 is a cross-sectional view of the duct joint member 82 coupled with the first duct member 108. Coupling the first and second duct members 108, 110 to the duct joint member 82 forms the air-tight joint between the two. To couple the first duct member 108 to the duct joint member 82, the first end 120 of the duct joint member 82 is inserted into the opening 114 at the first end 112 of the first duct member 108. A first edge 124 at the first end 112 of the first duct member 108 slides over the front face 18 of the first sheet section 24 and the first sealing ribs 38 of the air duct connector 10. The first edge 124 abuts the first bead 32 and the first bead 32 prevents advancement of the first duct member 108 past the first bead 32.

As the first duct member 108 passes over the front face 18 of the air duct connector 10, the first edge 124 pushes the first sealing ribs 38 towards the first bead 32. The first sealing ribs 38 are folded over from its base 62 towards the first bead 32. The flexibility of the sealing ribs permits the folding action. Once the first duct member 108 is in position, the first sealing ribs 38 are compacted between an inner surface 126 of the first duct member 108 and the front face 18 of the air duct connector 10. The sealing ribs create an air-tight seal between the first duct member 108 and the duct joint member 82.

Although not shown in FIG. 11, the second duct member 110 is coupled to the duct joint member 82 in a similar fashion as the first duct member 108. The second end 122 of the duct joint member 82 is inserted into the opening 118 at the first end 116 of the second duct member 110. A first edge 128 at the first end 116 of the second duct member 110 slides over the front face 18 of the second sheet section 26 and the second sealing ribs 40 of the air duct connector 10. The first edge 128 abuts the second bead 34 and the second bead 34 prevents advancement of the second duct member 110 past the second bead 34. As the second duct member 110 passes over the front face 18 of the air duct connector 10, the first edge 128 pushes the second sealing ribs 40 towards the first bead 32. The second sealing ribs 40 are folded over from its base 62 towards the second bead 34. Once the second duct member 110 is in position, the second sealing ribs 40 are compacted between an inner surface 130 of the second duct member 110 and the front face 18 of the air duct connector 10 to an air-tight seal between the second duct member 110 and the duct joint member 82.

The first and second tapered sections 50, 56 of the air duct connector 10 forming the first and second knife edges 46, 48, minimize air turbulence through the duct joint formed by the first duct member 108, the duct joint member 82 and the second duct member 110. A passageway 132 through the duct members narrows at the duct joint, which air flowing though the passageway 132 encounters. Arrow 133 indicates the flow of air through the passageway. The first and second knife edges 46, 48 of the air duct connector 10 direct air flowing through the passageway 132 toward the center of the passageway 132 without disrupting air flow or creating turbulence within the passageway 132.

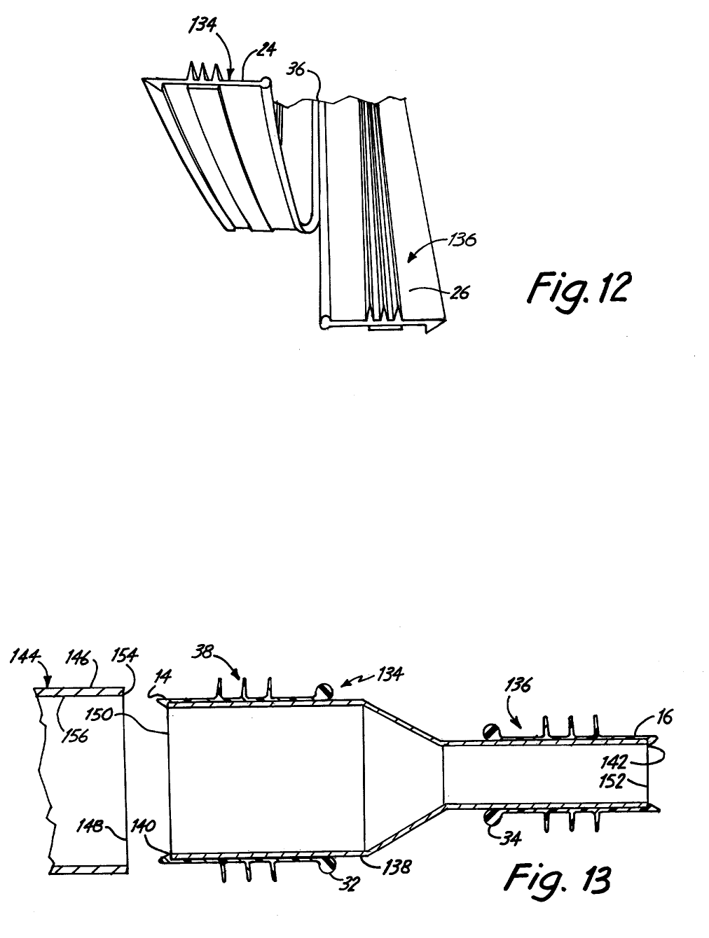

FIG. 12 is a front perspective view of an alternate embodiment of the present invention wherein the air duct connector 10 is separable. The air duct connector 10 of FIG. 12 has the same structure as the air duct connector 10 described in FIG. 3. The relative thinness of the connection bridge 36 with respect to the thickness of the gasket 12 permits separation of the air duct connector 10 along the connection bridge 36 into a first gasket 134 and a second gasket 136. Separation of the air duct connector 10 is preferably done manually by pulling the first sheet section 24 upward from the longitudinal plane of the gasket 12 and/or pushing the second sheet section 26 downward from the longitudinal plane (or vice versa).

The width of the connector duct member 80 is preferably equal to the width of the notch 68, about 4.5 inches. Often, the connector duct member 80 will have a width greater than 4.5 inches. In these situations, a wider air duct connector 10 is needed. Rather than providing a wider air duct connector, the present invention air duct connector 10 is separated into two separate gaskets, the first gasket 134 and the second gasket 136. As seen in FIG. 13, the first gasket 134 is wrapped around a duct fitting 138 wherein the first side edge 14 of the gasket is longitudinally aligned with a first edge 140 of the duct fitting 138. The second gasket 136 is wrapped around the duct fitting 138 wherein the second side edge 16 of the gasket is longitudinally aligned with a second edge 142 of the duct fitting 138. A duct joint similar to the one shown in FIGS. 10 and 11 is created, however, there is a gap between the first bead 32 and the second bead 34.

FIG. 13 is a cross-sectional view of a duct joint member comprised of the air duct connector 10 wrapped around and attached to the duct fitting 138. The air duct connector 10 is used to individually form an air-tight duct joint between a duct member 144 and the duct fitting 138. The air duct connector 10 may be manufactured as a single sheet or formed by separating the air duct connector 10 shown in FIG. 12 into the first gasket 134 and the second gasket 136. A single gasket is preferably used when creating an airtight seal between a single duct member 144 and the duct fitting 138, or second duct member. The duct member 144 has a first end 146 with an opening 148 and the duct fitting 138 has a first end 150 and a second end 152. The first gasket 134 is attached to the duct fitting 138 such that the first side edge 14 of the first gasket 134 is adjacent the first end 150 of the duct fitting 138. The second gasket 136 is attached to the duct fitting 138 such that the second side edge 16 of the second gasket 136 is adjacent the second end 152 of the duct fitting 138.

To form the air-tight duct joint between the duct member 144 and the duct fitting 138, the first end 150 of the duct fitting 138 is inserted into the opening 148 of the duct member 144. An edge 154 at the first end 146 of the duct member 144 slides over the front face 18 of the gasket and the sealing ribs 38 of the air duct connector 10. The edge 154 abuts the bead and the bead prevents advancement of the duct member 144 past the first bead 32. As the duct member 144 passes over the front face 18 of the air duct connector 10, the edge 154 pushes the sealing ribs 38 towards the bead and the sealing ribs 38 are folded over from its base 62 towards the bead. Once the duct member 144 is in position, the sealing ribs 38 are compacted between an inner surface 156 of the duct member 144 and the front face 18 of the air duct connector 10. The sealing ribs 38 create an air-tight seal between the duct member 144 and the duct fitting 138.

The air duct connector of the present invention is usable with air ducts of various diameters and widths. The air duct connector is cut into a desired length strip in the field, thus, it can be used with air ducts of any diameter and the user is not restricted to a specific size connector duct member. Furthermore, the air duct connector is separable into a first gasket and a second gasket. If the connector duct member has a width substantially larger than the width of the air duct connector, the single gaskets can be used along each edge of the connector duct member without compromising the integrity of the air-tight joint. In addition, the separable air duct connector permits use of a single gasket to be used to connect a duct member and a duct fitting without requiring a connector duct member.

The air duct connector of the present invention is quickly and easily attachable to the connector duct member, whether the connector is pre-fabricated or manufactured on site. Once the air duct connector is cut to a desired length, the protective layer over the adhesive backing is removed and the gasket is wrapped around the connector duct member until it fully encircles the connector duct and the ends mate up at a sealing seam. Even if the length of the gasket is longer or shorter than the circumference of the connector duct member, matched, angled ends permit positioning of the ends until they match up to form the seal. The air duct connector does not wrap around the edges of the connector duct such that it has to be slid onto the connector duct with axial movement.

Although the present invention has been described with reference to preferred embodiments, workers skilled in the art will recognize that changes may be made in form and detail without departing from the spirit and scope of the invention. For example, fewer or more flexible fins could be used and the cross-sectional shape of the beads could include oval, square, rectangle, etc. The adhesive backing could be located on the connector duct member as opposed to the gasket. Furthermore, the adhesive backing could include a plurality of pieces in varying shapes. Finally, the air duct connector (as a single gasket) could be attached to an outer surface of the air duct members rather than the connector duct member, such that the air duct members are inserted into the connector duct member.

1. A method of using an air duct connector, comprising:
cutting a strip of an air duct connection gasket along a first start edge, the air duct connection gasket comprising:
a first sheet section extending generally in a planar sheet between a first sheet longitudinal side edge and a first sheet longitudinal central edge, the first sheet section having a first sheet width which is substantially wider than a first sheet thickness;
a first sealing rib extending longitudinally on a front face of the first sheet section, the first sealing rib defining a flexible fin;
a second sheet section extending generally in a planar sheet between a second sheet longitudinal side edge and a second sheet longitudinal central edge, the second sheet section having a second sheet width which is substantially wider than a second sheet thickness;
a second sealing rib extending longitudinally on a front face of the second sheet section, the second sealing rib defining a flexible fin; and
a bead extending longitudinally between the first and second sheet sections along the longitudinal central edges, the bead having a bead thickness which is substantially thicker than the first sheet thickness and substantially thicker than the second sheet thickness, the bead having a bead width which is substantially narrower than the first sheet width and substantially narrower than the second sheet width;
an adhesive backing on a back face of the first and second sheet sections opposite the front faces;
adhesively attaching the strip around a metal connector band such that the air duct connection gasket fully encircles the metal connector band, the adhesive attachment being formed with the adhesive backing;
cutting the strip along a second close edge which matches the first start edge; and
positioning the strip such that the first start edge mates together with the second close edge at a sealing seam.

2. The method of claim 1, and further comprising:
cutting the first start edge at a non-perpendicular angle to the longitudinal side edges;
cutting the second close edge at a non-perpendicular angle to the longitudinal side edges, wherein the second close edge matches the first start edge; and
positioning the strip such that the sealing seam is at a non-perpendicular angle to the longitudinal side edges.

3. The method of claim 1, and further comprising:
removing a self-peeling protective layer covering the adhesive backing prior to adhesively attaching the strip around the metal connector band.

5. The method of claim 1, and further comprising:
inserting a first end of the metal connector band into an opening of a first duct member wherein the first sealing rib contacts an inner surface of the first duct member and an end of the first duct member abuts the bead adjacent the first sheet section; and
inserting a second end of the metal connector band into an opening of a second duct member wherein the second sealing rib contacts an inner surface of the second duct member and an end of the second duct member abuts the bead adjacent the second sheet section.

6. An air duct connector comprising:
a gasket formed of a single strip of flexible, compressible material, the gasket comprising:
a first sheet section extending generally in a planar sheet between a first sheet longitudinal side edge and a first sheet longitudinal central edge, the first sheet section having a first sheet width which is substantially wider than a first sheet thickness;
a first sealing rib extending longitudinally on a front face of the first sheet section, the first sealing rib defining a flexible fin;
a second sheet section extending generally in a planar sheet between a second sheet longitudinal side edge and a second sheet longitudinal central edge, the second sheet section having a second sheet width which is substantially wider than a second sheet thickness;
a second sealing rib extending longitudinally on a front face of the second sheet section, the second sealing rib defining a flexible fin; and
a bead extending longitudinally between the first and second sheet sections along the longitudinal central edges, the bead having a bead thickness which is substantially thicker than the first sheet thickness and substantially thicker than the second sheet thickness, the bead having a bead width which is substantially narrower than the first sheet width and substantially narrower than the second sheet width; and
an adhesive backing on a back face of the first and second sheet sections opposite the front faces.

7. The air duct connector of claim 6, and further comprising:
a self-peeling protective layer covering the adhesive backing.

8. The air duct connector of claim 6 wherein the adhesive backing extends along the back face.

9. The air duct connector of claim 6 wherein the adhesive backing comprises:
a first adhesive backing extending along the back face of the first sheet section opposite the first sealing rib; and
a second adhesive backing extending along the back face of the second sheet section opposite the second sealing rib.

10. The air duct connector of claim 6, and further comprising:
a first tapered section extending longitudinally along the first sheet longitudinal side edge, the first tapered section having a front face which is coplanar with the front face of the first sheet section, the first tapered section having a rear face which widens from a first knife edge and extends at an angle relative to the back face of the first sheet section; and
a second tapered section extending longitudinally along the second sheet longitudinal side edge, the second tapered section having a front face which is coplanar with the front face of the second sheet section, the second tapered section having a rear face which widens from a second knife edge and extends at an angle relative to the back face of the second sheet section.

11. The air duct connector of claim 6, and further comprising:
a notch defined along the back face of the first and second sheet sections between the first sheet longitudinal side edge and the second sheet longitudinal side edge, the notch having a first notch end adjacent the first sheet longitudinal side edge and a second notch end adjacent the second sheet longitudinal side edge wherein the first and second notch ends define the notch and the notch is sized to receive a connector duct member therein.

12. The air duct connector of claim 6 wherein the first sheet thickness and the second sheet thickness is about 0.032 inches, the first sheet width and the second sheet width is about 2.2 inches, and the first sealing rib and the second sealing rib have heights of about 0.275 inches.

13. The air duct connector of claim 6 wherein the first and second sealing ribs extend substantially perpendicular to the front faces of the first and second sheet sections.

14. The air duct connector of claim 6 wherein the first and second sealing ribs have a lateral cross-sectional width which decreases from a base of the sealing rib to a top of the sealing rib.

15. The air duct connector of claim 6 wherein the first sealing rib is comprised of three flexible fins spaced apart from each other and the second sealing rib is comprised of three flexible fins spaced apart from each other.

16. The air duct connector of claim 6, and further comprising:
a connector duct member wherein the gasket fully encircles the metal connector and the gasket is attached to the connector duct member by the adhesive backing.

17. An air duct connector comprising:
a gasket formed of a single strip of flexible, compressible material, the gasket comprising:
a first sheet section extending generally in a planar sheet between a first sheet longitudinal side edge and a first sheet longitudinal central edge, the first sheet section having a first sheet width which is substantially wider than a first sheet thickness;
a first bead extending longitudinally along the first sheet longitudinal central edge, the first bead having a first bead thickness which is substantially thicker than the first sheet thickness and a first bead width which is substantially narrower than the first sheet width;
a second sheet section extending generally in a planar sheet between a second sheet longitudinal side edge and a second sheet longitudinal central edge, the second sheet section having a second sheet width which is substantially wider than a second sheet thickness;
a second bead extending longitudinally along the second sheet longitudinal central edge, the second bead having a second bead thickness which is substantially thicker than the second sheet thickness and a second bead width which is substantially narrower than the second sheet width;
a connection bridge attaching the first bead and the second bead, the connection bridge being narrower than either the first bead width or the second bead width, the connection bridge being thinner than either the first sheet thickness or the second sheet thickness; and
an adhesive backing extending along a back face of the first and second sheet sections opposite the front faces.

18. The air duct connector of claim 17 wherein the gasket is separable into a first gasket and a second gasket at the connection bridge.

19. The air duct connector of claim 18 wherein the adhesive backing is comprised of a first adhesive backing extending along the back face of the first sheet section opposite the first sealing rib and a second adhesive backing extending along the back face of the second sheet section opposite the second sealing rib.

20. The air duct connector of claim 17, and further comprising:
a first sealing rib extending longitudinally on a front face of the first sheet section, the first sealing rib defining a flexible fin; and
a second sealing rib extending longitudinally on a front face of the second sheet section, the second sealing rib defining a flexible fin.

21. The air duct connector of claim 17, and further comprising:
a notch defined along the back face of the first and second sheet sections between the first sheet longitudinal side edge and the second sheet longitudinal side edge, the notch having a first notch end adjacent the first sheet longitudinal side edge and a second notch end adjacent the second sheet longitudinal side edge wherein the first and second notch ends define the notch and the notch is sized to receive a connector duct member therein.

22. The air duct connector of claim 17, and further comprising:
a first tapered section extending longitudinally along the first sheet longitudinal side edge, the first tapered section having a front face which is coplanar with the front face of the first sheet section, the first tapered section having a rear face which widens from a first knife edge and extends at an angle relative to the back face of the first sheet section; and
a second tapered section extending longitudinally along the second sheet longitudinal side edge, the second tapered section having a front face which is coplanar with the front face of the second sheet section, the second tapered section having a rear face which widens from a second knife edge and extends at an angle relative to the back face of the second sheet section.

23. A self-sealing gasket for creating an air-tight seal between a first duct member and a second duct member where the first duct member is inserted into an opening at one end of the second duct member, the gasket comprising:
a flexible strip having a front face and a back face, the strip extending laterally between a first side edge and a second side edge;
an adhesive backing for attaching the gasket to an outer surface of the first duct member;
a projection extending from the front face of the strip and along the second side edge of the strip wherein the projection prevents the second duct member from passing over the projection; and
at least one sealing rib extending longitudinally on the front face of the strip, the sealing rib defining a flexible fin wherein the fin creates the air-tight seal between the first duct member and the second duct member.
